(19) United States
(12) Patent Application Publication
(10) Pub. No.: US 2016/0101973 A1
(43) Pub. Date: Apr. 14, 2016

(54) MODULAR SADDLE TREE WITH A GULLET PLATE

(71) Applicant: Jochen HENNIG, Mühlenberge OT Haage (DE)

(72) Inventor: Jochen HENNIG, Haage (DE)

(21) Appl. No.: 14/890,920

(22) PCT Filed: May 29, 2014
(86) PCT No.: PCT/EP2014/061211

§ 371 Date: Nov. 13, 2015

(30) Foreign Application Priority Data
May 29, 2013 (DE) 10 2013 105 569.9

(51) Int. Cl. B68C 1/02; B68C 1/04

(52) U.S. Cl. CPC B68C 1/025; B68C 1/04

(57) ABSTRACT

Instant invention relates to a modular saddle tree for a riding saddle with a gullet plate comprising a gullet plate element and a shank, wherein a supporting element is attached to the shank of the gullet plate by means of a fastening device, particularly moveably supported, a saddle comprising the modular saddle tree according to the invention, a shank comprising a fastening device for a supporting element and a supporting element as well, and a gullet plate comprising a gullet plate element and a shank according to the invention.

### TECHNICAL AREA AND STATE OF THE ART

Instant invention relates to a modular saddle tree for a riding saddle with a gullet plate comprising a gullet plate element and a shank, wherein a supporting element is attached to the shank of the gullet plate by means of a fastening device, particularly moveably supported, a saddle comprising the modular saddle tree according to the invention, a shank comprising a fastening device for a supporting element and a supporting element as well, and a gullet plate comprising a gullet plate element and a shank according to the invention.

FIG. 1 shows a saddle tree according to the state of the art. Many riding saddles have a saddle tree 10 with a side-cut 14, which extends between a pommel 12 facing the head of the animal, also known as fork or saddle head, and a cantle 13. The pommel 12 generally comprises two points 15 that extend downwards like wings. For reinforcement, a brace that extends into the points 15, is frequently associated with the pommel 12, which is commonly known as gullet plate. The gullet plate 30 generally comprises two shanks 24, which are attached to the connecting element 16 by means of a U-shaped connecting element 16 of the gullet plate 30 that is arranged in the centre, i.e., the shanks 24 extend from the connecting element 16 essentially in the downward direction and terminate in the shank ends 21. The gullet plates 30 known from the state of the art are thus designed in one piece comprising a connecting element 16 and shank 24, in order to ensure the desired reinforcement for the front part of the saddle tree 10. In addition, many saddle trees have two longitudinal bars 17, that extend from the pommel 12 to the cantle 13. The seating area 11 of a saddle extends between the pommel 12 and the cantle 13 and may have a side-cut 14. Saddles having such a saddle tree are widely used because they are stable and provide excellent functionality in terms of steering, footing, stability and close contact between the horse and the rider.

Optimising the saddle to anatomically fit the horse and the rider is basically one of the main challenges for the saddler. A particularly difficult aspect while manufacturing saddles with a saddle tree and gullet plate is in ensuring the freedom of movement for the spine, flexing of muscles and shoulder movements near the forelegs of the animal by optimally adjusting the saddle without adversely affecting the above mentioned functional characteristics of the saddle in the process. A specific problem associated with this is that the animal undergoes certain anatomical changes over time, e.g., due to muscular development or atrophies, that may be caused by growth, exercise or improper loading. The original fit of the saddle is lost because of this, it results in improper loading and leads to health problems and/or loss of performance of the animal. Since the thoracic spine of the horse has 18 thoracic vertebrae and has cartilaginous dorsal processes near the withers that lie just below the skin, these can be severely aggravated if the saddle does not fit properly leading to health problems and significantly hinder the freedom of movement of the horse. This especially relates to the area of the trapezius.

It is therefore desirable to be able to flexibly adjust the fit to the anatomy of the horse in a cost-effective and simple manner even in case of high quality saddles in order to prevent detrimental effects on the health of the animal or to counteract them at an early stage and it is desirable to adjust the fit to the anatomy of the horse from the area of the dorsal processes downwards including the trapezius. Although the skilled person has been aware of these problems for a long time and many proposals have already been made for (partly) solving these problems, something still needs to be done because the relevant sections of the known saddles and saddle trees cannot be modified without considerable effort or loss of stability due to their structural design. In case of the known saddle trees, the shanks on the gullet plate cannot be modified after fabricating the saddle anyway because the shanks and gullet plate are usually forged into one piece and the shanks are generally attached to the saddle or the saddle tree and cannot be accessed.

Even in case of known saddle trees having multi-piece gullet plates, a lot of manual work is required in the saddle structure to make the necessary adjustments. In case of the known saddle trees, adjustments are mostly made to the points or the shank ends as well as the gullet width. However, finer adjustments are often required for fitting the saddle optimally, which for example, relate to the areas of the trapezius or the shoulder axis of the animal.

In case of the saddle trees without a gullet plate known to the state of the art, it is often intended to design the saddle tree to be very flexible. However, the known saddle trees without a gullet plate have the disadvantage that they do not exhibit the desired carrying or supporting force required for a saddle tree, due to the reduced supporting surface.

Hence DE 202010010215 U1 shows a saddle tree having a variable gullet width, where the shanks are adjustably connected to the gullet plate by means of pivoting sleeves on a common pivoting axis. The disadvantage of the disclosed gullet plate-like design is that the multi-piece pivoting sleeve is difficult to manufacture and requires a lot of space. DE 202012101416 U1 shows a saddle tree with a fixture for the seating area having two hinges respectively on each shank, which can pivot in two different directions. DE 102011051014 A1 shows a saddle tree with gullet plate with tips offset backwards and designed to swing. The arch shape of the tips has to be specifically adjusted to the amount of movement of the shoulder blade of the horse by customising it. EP 1785390 A1 shows a saddle with a gullet plate, having gullet plate ends provided on the shank ends that taper off broadly and curve backwards, and can be detached at the ends of the gullet plate shanks. The gullet plate ends that points backwards form a contact surface that is not in the same plane as the gullet plate shank.

Finally, DE 19956405 C2 shows a saddle having a gullet plate, whose ends are connected to openings of the gullet plate by means of fastening devices, such that they are detachably connected.

### PROBLEM AND SOLUTION

Therefore, it is the general objective of instant invention to overcome the disadvantages of the state of the art, thereby avoiding a complete re-fabrication of the gullet plate or saddle tree, in order to make the necessary adjustments to the saddle based on the change in anatomy of the animal. To eliminate the aforementioned disadvantages of the state of the art, instant invention provides a solution with the features mentioned in the claims by providing a saddle tree that allows these adjustments and modifications to be carried out cost-effectively and with comparatively less effort, especially if adjustments are required not only at the points, but for example, even in the areas beyond it, especially the area of the shoulder muscles and the foreleg of the animal. According to the underlying problem, the high stability of the gullet plate and the entire saddle tree along with its elements should be ensured despite the variability of the gullet plate in order to adequately guarantee the supporting function of the saddle tree. In addition, the advantages mentioned according to the invention with regards to the improved fit of the saddle tree, especially when the animal is moving, are retained. This combination of problems is resolved by the objects of the independent patent claims in terms of their features. Further advantageous developments and improvements are mentioned in the depending claims.

Unless specified otherwise, all information pertaining to the direction, orientation or similar information concerning the arrangement or orientation of the saddle elements or their relative position to one another according to the invention, are based on the normal seating position of the rider when the saddle is being used for the intended purpose. The longitudinal direction and the transverse direction are also shown in FIG. 1.

Thus, a first object of the invention is a modular saddle tree for a riding saddle having a gullet plate, wherein the gullet plate comprises
a) a gullet plate element and
b) a shank with a supporting element, characterised in that
c) the supporting element is attached to the said shank of the gullet plate by means of a fastening device, preferably in a flexible manner, in particular moveably mounted, wherein the said supporting element is even more preferred reversibly detachable mounted and, optionally, is fixed or reversibly detachably fixed. In another embodiment of the saddle tree according to the invention, the shank is detachably fixed to the gullet plate element by means of a first mounting fixture, preferably reversibly detachably fixed. In an alternative embodiment of the saddle tree according to the invention, the gullet plate is designed with a crank. In yet another alternative embodiment of the saddle tree according to the invention, it also comprises a stirrup bar, which is fixed to the saddle tree independent of the shank, preferably detachably fixed by means of a second mounting fixture, optionally reversibly detachably, preferably adjustable, to vary at least one angle between the stirrup bar and the shank.

In yet another alternative embodiment of the saddle tree according to the invention, the shank and stirrup bar are designed as one-piece. Optionally, the shanks and/or the stirrup bars are fixed using a damping means in the saddle tree according to the invention.

The term “gullet plate” according to instant invention means a one-piece or multi-piece gullet plate comprising a gullet plate element, which is designed as an arc or U-shaped, and one or more shanks and, optionally, bracing elements to reinforce the saddle tree. The elements of the gullet plate are generally made from metal, plastic, or composites reinforced with glass fibre or carbon fibre or other materials suitable for this purpose and adapted to the shape of the gullet curvature. The gullet plate generally tapers away from the withers towards outside, wing-like to the right and left sides of the animal, in a more or less symmetrical manner going downwards and in one embodiment of the invention, optionally comprises the shanks up to the points.

The gullet plate up to the casting that is including the shank is mostly forged throughout the section that is facing downwards, provided it is made of metal.
In an alternative embodiment of the invention, the gullet plate, resp., the gullet plate element is attached to the side of the horse, i.e., to the inner side of the saddle tree.

According to the invention, the gullet plate element and shank may be made from the same or different materials. In yet another embodiment of the invention, the gullet plate element and shank are made from different materials, especially materials having different bending strengths or different modulus of elasticity, preferably, the shank is made from a material having a lower absolute value of the bending strength compared to the gullet plate element, e.g., a relatively rigid forged or casted part made of spring steel or the like. The shanks may be made from a material that is more elastic than the gullet plate element, like for example, spring steel, titanium, composites reinforced with carbon fibre. The shank ends can be made from the above mentioned materials or an elastically deformable material. According to the invention, the “upper area of the gullet plate” means the area that preferably comprises the upper 80% of the gullet plate, more preferably the upper 65% and even more preferably the upper 50%, related to the spatial dimensions of the entire gullet plate, i.e., of the gullet plate element and the shank.

In one embodiment of the invention, the term “shank” means a part section of the gullet plate, which essentially comprises its entire segment that is facing downwards. In this case, the shank comprises about 20 to 40% (w/w), preferably about 30 to 40% (w/w), more preferably about 35 to 40% (w/w) of the entire gullet plate 30. Especially about 20 to 40%, preferably 30 to 40%, more preferably 35 to 40% of the length of the gullet plate is encompassed starting from the shank end.

In a preferred embodiment of the invention, the first mounting fixture is arranged in the upper section of the gullet plate.

In another embodiment of the invention (not shown), the transition area from the gullet plate element to the shank has a cranked design.

According to the invention, the term “supporting element” means an element that is connected to a shank of the gullet plate of the saddle tree by means of a fastening device, which is attached to the shank of the gullet plate, preferably in a flexible manner, in particular free moveably mounted, and even more preferred reversibly detachable mounted. According to the invention, the term “supporting element” hence means an element that is indirectly connected to the saddle tree via the gullet plate, which extends the load bearing supporting surface of the saddle tree, also ensures this when the animal is moving and especially is arranged in the area of the trapezius. The supporting element may be provided in the area of the points, so that, when the saddle tree is used properly, it comes into contact with the horse directly or via a padding attached to the supporting element. In another preferred embodiment of the invention, the supporting element extends from the padding line till the points. A supporting element arranged such that it is reversibly detachable provides the advantage that the supporting surface can be replaced and flexibly adapted to the anatomy of the horse.

In one embodiment of the invention, the supporting element is exclusively attached to the shank of the gullet plate by means of the fastening device such that it can move freely, in order to allow it to be flexibly adapted to the anatomy of the animal with maximum possible freedom of movement for the animal's muscles. In another embodiment, the supporting element is essentially positioned in the centre with relation to the shank. In another embodiment, the supporting element is attached to the shank by means of one or more attachment points, or by means of a U-shaped support.

According to the invention, the shape and position of the shank and the shape and position of the supporting element, allow the adjustment of the fit of the saddle tree to the contour of the horse or the anatomy of the horse.

In this respect, the supporting element is preferably proximally attached to the shank according to the invention, i.e., on the side facing the horse. The fastening device for fixing the supporting element to the shank is essentially positioned above the shank end. In another embodiment of the invention, the supporting element is designed wider than the shank of the gullet plate, in order to achieve the maximum possible surface contact of the supporting element on the horse, whereby the supporting element may be 1.5 to 5 times the width of the shank in relation to its supporting surface. In another embodiment of the invention, the supporting element with its longest side is essentially aligned in parallel to the longitudinal direction of the shank that is essentially facing downwards. In another embodiment of the invention, the gullet plate element is not attached to the side facing the horse and the supporting element is attached to the side facing the horse.

According to instant invention, the term “fastening device” means all the connecting means known to the skilled person and suitable for the purposes of the invention, preferably force-fit and positive-fit connecting means, which are suitable for connecting the elements to be joined according to the invention. This also includes plugging, locking, screwing or clamping or clipping means, which are optionally designed as variable fixtures and are suitably provided for the appropriate openings, holes, guides, locking elements, grooves, riveted joints, pins, stays or screw threads, screws, nuts, clips, springs, teeth of the respective mounting fixture, which for example, can be designed as a slide bar, a connecting fixture that can be eccentrically turned and adjusted, a perforated plate or bar, an end face having teeth or in any other manner known to the skilled person. Optionally, the fastening device according to the invention may comprise a damping means.

The fastening device according to the invention may comprise an elastic material which is connected to the respective shank on one side and the supporting element on the other side via an adhesive joint. Foam, rubber, elastic plastic (elastomers) or other suitable materials that are reversibly deformable may be used as the elastic material.

In addition, the fastening device can be supplemented by other known types of fastening means, e.g., by means of a screw connection in order to essentially use the elastic material as a damping means which is used for damping the movement between shank and supporting element. Without an additional fastening device, a fastening means made of elastic material serves to fix the supporting element to the shank and also in damping the movement of the supporting element on the shank.

In a preferred embodiment of the invention, the fastening device is arranged in the upper section of the gullet plate.

According to the invention means “reversibly detachable connected”, resp., “reversibly detachable fixed” preferably that elements, optionally firmly connected to each other, can be separated, resp., detached without destroying them, optionally with the exception of any single-use fastening means like rivets, snap connectors etc.

According to the invention, the term “first mounting fixture” preferably means any positive-fit or force-fit fixture known to the skilled person, which is suitable for reversibly detaching and fixing the elements to be joined according to the invention. This preferably comprises one or more materials, like e.g., metal, plastic or composites reinforced with glass fibre or carbon fibre or other materials known to the skilled person which are suitable and may in a preferred embodiment of the invention be designed as part of the element to be connected. Plugging, screwing or clamping fixtures may be suitable for this purpose, which are designed as variable fixtures and have appropriate opening, holes, guides, locking elements, grooves, pins, stays, clamps or screw threads. The first mounting fixture can hence be designed, for e.g., as a slide bar, a connecting fixture that can be eccentrically turned and adjusted, a perforated plate or bar, an end face having teeth or in any other manner known to the skilled person.

In another embodiment of the invention, the first mounting fixture 20 is roughly located in the area of the padding line (not shown) of the saddle tree. The reversibly detachable fixing of the shank on the gullet plate element by means of the first mounting fixture provides the advantage that the shank can be replaced and flexibly adapted to the anatomy of the horse.

According to the invention the terms “crank”, “cranking at right angles” or “cranked design” preferably means an offset on a component.

According to the invention the term “stirrup bar” preferably means a saddle element, which is used for supporting the stirrup mount. In one of the embodiment of the invention, the stirrup bar is directly or indirectly connected to the saddle tree and/or the gullet plate via other saddle or saddle tree components. In one embodiment of the invention, the stirrup bar is not directly connected to the shank and in an alternative embodiment of the invention, it is directly connected to the shank. In yet another embodiment of the invention, the stirrup bar is designed as one-piece with the shank. The stirrup bars can be attached to the saddle tree via the said second mounting fixture and/or on the gullet plate via the first mounting fixture.

In another embodiment of the invention, the shank and stirrup bar are designed as one piece. In yet another embodiment of the invention, the shank and/or stirrup bar are reversibly detachable fixed by means of a suitable fastening device and/or damping means.

In yet another embodiment of the invention, the said first and/or second mounting fixture 20, 22 is provided for variably adjusting at least one angle between the stirrup bar 18 and the shank 24. According to the invention, the term “angle between the stirrup bar and shank” preferably means any possible angle with respect to the three spatial axes. Adjustment options may be required to fit the elements to be modified according to the invention, to the gullet shape of the animal in all the spatial directions.

Preferably, in one of the embodiment of the invention, the said mounting fixture allows variable adjustment of two angles between the stirrup bar 18 and the shank 24.

According to the invention, the term “longitudinal bar” preferably means an additional strut member of the saddle tree, which essentially extends backwards parallel to the spinal column of the animal, preferably in the form of a bar or strip. In one embodiment of the invention the longitudinal bar is connected to the gullet plate.

According to the invention, the term “second mounting fixture” preferably means any positive-fit or force-fit fixture, which is suitable for mounting, resp., reversibly detaching and fixing the elements to be joined according to the invention. This preferably comprises one or more materials like metal, plastic or composites reinforced with glass fibre or carbon fibre or any other materials that are suitable and known to the skilled person for saddle trees, gullet plates or stirrup bars. This also includes plugging, screwing or clamping fixtures, which are optionally designed as variable fixtures and have appropriate openings, holes, guides, locking elements, grooves, pins, stays, clamps or screw threads. The second mounting fixture can hence be designed, e.g., as a slide bar, a connection that can be eccentrically turned and adjusted, a perforated plate or bar, an end face having teeth or in any other manner known to the skilled person. In another embodiment of the invention, the said second mounting fixture is suitable for fixing the elements to be attached according to the invention by means of one or more suitable fastening means. In a preferred embodiment of the invention, the second mounting fixture comprises a damping means.

According to the invention, the term “damping means” preferably means any suitable means for the skilled person, for fixing, i.e., to flexibly mount an element to be fixed according to the invention, i.e., to elastically design the fixing point.

Examples of damping means are spring rings, spring bushes, spring washers or any suitable damping made of elastomers, like foam, rubber, cork or other suitable plastics or natural materials.

In another embodiment of the invention, the saddle tree has two shanks, wherein a respective first mounting fixture is associated with each shank and the shanks are reversibly detachable fixed to the gullet plate element by means of the first mounting fixture.

In another embodiment of the invention, the said mounting fixture can be functionally combined with the fastening device into one fixture such that the shank is simultaneously reversibly detachable fixed to the gullet plate element and the supporting element is flexibly and reversibly detachable attached to the shank. The combination of mounting fixture and fastening device can thus be provided with different versions of the shanks, such that the modular saddle tree becomes very variable.

A second object of the invention is a riding saddle that comprises a saddle tree according to the invention. Preferably, the padding, cushioning, costumes and/or other coverings and seat covers are fitted such that all the fixable parts of the gullet plate that can be reversibly detached, are easily accessible, i.e., the access to the said fastening devices, the first and/or second mounting fixtures is guaranteed and thus the shank can be changed and/or adjusted according to the invention.

A third object of the invention is a shank comprising a) a fastening device for a supporting element and b) a supporting element, preferably as defined according to the invention, more preferably for attaching to a first mounting fixture of a gullet plate element in a positive-fit and/or force-fit manner, preferably, wherein the shank is reversibly detachable fixed to the gullet plate element.

According to the invention, the shank may optionally comprise additional components, e.g., a fastening device for a supporting element or a stirrup bar.

And finally, a fourth object of the invention is a gullet plate comprising a) a gullet plate element and b) at least one shank as defined according to the invention, wherein the gullet plate is designed as one-piece or multi-piece.

Some of the embodiments of the invention are described below and are illustrated schematically by means of the figures.

### BRIEF DESCRIPTION OF THE FIGURES

FIG. 1 shows a schematic view of a saddle tree having basic elements as known from the state of the art.

FIG. 2 shows a schematic view of a saddle tree according to the invention having supporting elements according to a first embodiment of the invention.

FIG. 3 shows a schematic view of a saddle tree according to the invention having supporting elements according to a second embodiment of the invention with a cranked shank.

FIG. 4A shows a front view of a saddle tree according to FIG. 2 of the invention having one gullet plate and supporting elements attached thereto.

FIG. 4B shows a front view of a saddle tree according to the invention having supporting elements attached to the gullet plate, wherein the gullet plate has an offset formed by overlapping.

FIG. 4C shows a front view of a saddle tree according to the invention having supporting elements attached to the gullet plate, wherein the gullet plate is designed with a crank.

FIG. 4D shows a front view of a saddle tree according to the invention having supporting elements attached to the gullet plate, wherein the gullet plate has S-shaped sections and the points form the supporting elements.

FIG. 5 shows a side view of a saddle tree according to the invention having supporting elements on the gullet plate according to FIG. 4C.

FIG. 6 shows a schematic view of a saddle tree according to the invention, which is additionally reinforced by means of a cantle bar and longitudinal bars, each being connected to the shanks via respective second mounting fixtures.

FIG. 7 shows a schematic view of a saddle tree according to the invention, whose longitudinal bars are connected to a stirrup bar via respective second mounting fixtures.

FIG. 8 shows a schematic view of a saddle tree according to the invention, whose longitudinal bars are connected to a stirrup bar via respective second mounting fixtures and to the shanks via respective second mounting fixtures.

FIG. 9 shows a schematic view of a saddle tree according to the invention, whose longitudinal bars are connected to a stirrup bar and the shank via respective second mounting fixtures. Additionally, the shanks have broadened shank ends.

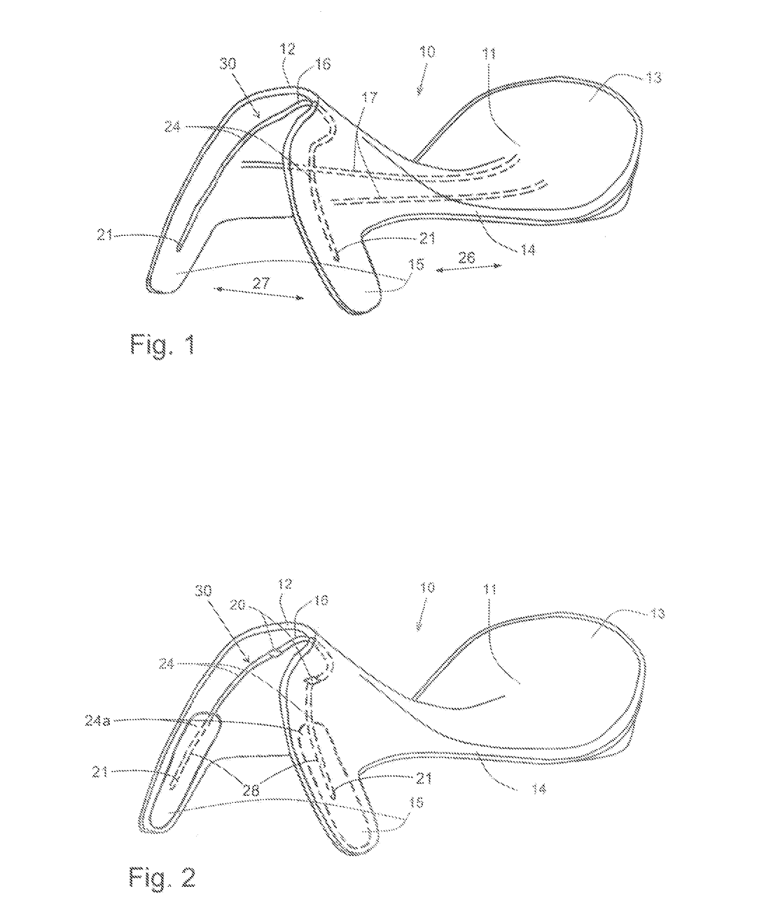

### DETAILED DESCRIPTION OF THE INVENTION

FIG. 2 shows a first embodiment of the saddle tree 10 according to the invention. The saddle tree 10 has a seating area 11 with a side cut 14, which extends between the pommel 12 that faces the head of the animal and a cantle 13. For reinforcement, a gullet plate that extends into the points 15, is associated with the pommel 12.

The gullet plate 30 comprises two shanks 24, which are attached to the gullet plate element 16 by means of a U-shaped gullet plate element 16 of the gullet plate 30 that is provided in the centre, i.e., the shanks 24 extend from the gullet plate element 16 essentially inside the pommel 12 along the sides of the animal in the downward direction and terminate in the shank ends 21. The gullet plates 30 are thus designed in one piece comprising a gullet plate element 16 and shank 24, in order to ensure the desired reinforcement for the front part of the saddle tree 10. As shown in FIG. 2, it is intended that the gullet plate 30 can be alternatively designed modularly, wherein a first mounting fixture 20 is provided between the gullet plate element 16 and the shank 24 in this case. The mounting fixture 20 allows the shank 24 to be reversibly detachable fixed to the gullet plate element 16, in order to easily replace the shank 24 along with all the components on it. Thus, the shank 24 and the gullet plate element 16 can be combined with different rigidities, in order to individually adapt the flexibility of the pommel 12 on the saddle tree 10 by means of the gullet plate 30.

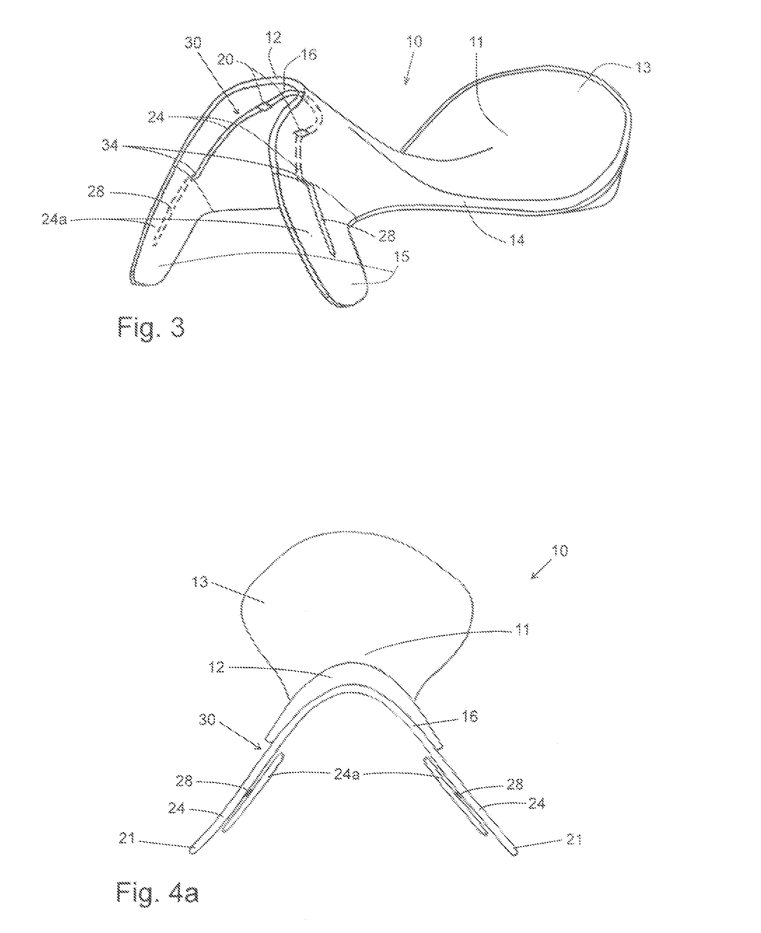

FIG. 3 shows a schematic view of another embodiment of the saddle tree according to the invention having supporting elements 24a. The shanks 24 of the gullet plate 30 have a crank 34. The crank 34 allows to guide the shank 24 of the gullet plate 30 from the inner part of the pommel 12 of the saddle tree 10 to the outside. The advantage of this is that the supporting elements 24a can align with the internal upper part of the pommel 12 and hence the space for the pommel 12 of the saddle tree 12 can be reduced. As shown in by example of FIG. 2, the supporting elements 24a can be flexibly attached to the shanks 24 of the gullet plate 30 by means of the fastening devices 28. As shown further in FIG. 3, the supporting elements 24a can alternatively designed as points 15 that are independent from the saddle tree or arranged in the area of the points 15, such that a larger contact area of the supporting element 24a is available, as shown in the arrangement in FIG. 2.

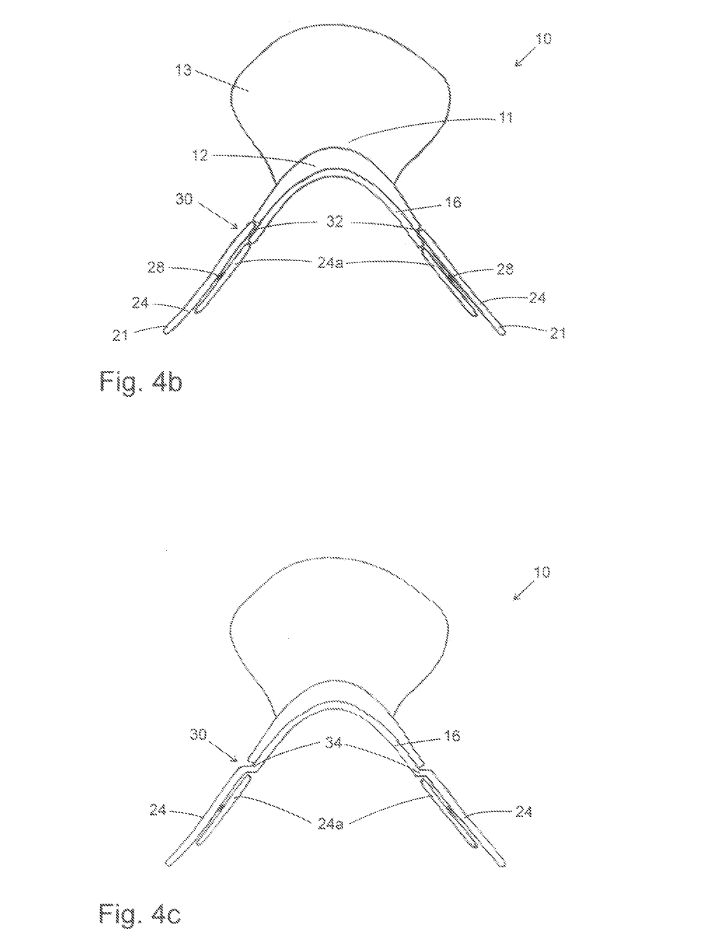

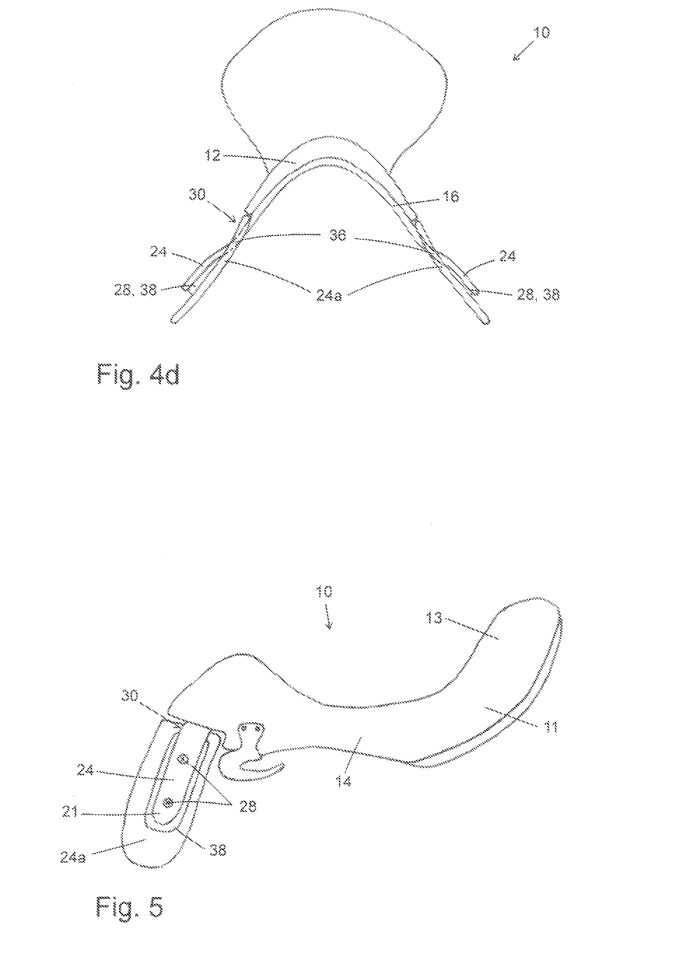

FIG. 4A shows a front view of a saddle tree according to the invention. The pommel 12 and the gullet plate 30 are visible next to the cantle 13 and the seating surface 11. The gullet plate 30 is designed as a single piece and comprises a gullet plate element 16, shank 24 and shank ends 21. The supporting elements 24a are attached to the shanks 24 by means of fastening devices 28.

FIG. 4B shows another front view of a saddle tree according to the invention. The pommel 12 and the gullet plate 30 are visible next to the cantle 13 and seating surface 11. The gullet plate 30 is shown as multi-piece and comprises a gullet plate element 16, shank 24 and shank ends 21. The supporting elements 24a are attached to the shanks 24 by means of fastening devices 28. The multi-piece design of the gullet plate 30 has the advantage that a staggered arrangement of the supporting elements 24a is possible from an overlap 32 arising from an overlapping arrangement of the gullet plate element 16 and the shanks 24. In this manner, the supporting elements 24a and the side of the gullet plate element 16 facing the horse can be aligned, i.e., arranged such that they are aligned in a line. This allows an optimal arrangement and fit of the saddle tree 10 on the horse.

FIG. 4C shows another front view of a saddle tree according to the invention and represents another embodiment of the saddle tree shown in FIG. 4B. The aligned arrangement of the supporting elements 24a with the side of the gullet plate element 16 facing the horse is achieved in this case by a crank 34 of the gullet plate 30 designed as a single piece.

FIG. 4D shows another front view of a saddle tree according to the invention and represents an alternative of the saddle trees shown in FIG. 4B and 4C. The crank is reduced in this embodiment and forms an S-shaped arc 36. In addition, the supporting elements 24a are shown to be larger than in FIGS. 4A-C. In particular, one shank 24 penetrates the respective supporting element 24a. Thus, the supporting elements 24a can align with the side of the pommel 12 facing away from the horse or other components of the saddle tree 10 or the saddle. Thus, aligned/smooth transitions can be achieved in the saddle structure. Further, a damping effect can be achieved by appropriately designing the supporting element 24a, if the saddle tree 10 is used for the intended purpose.

In the embodiment shown in FIG. 4D, the respective supporting element 24a is connected to the respective shank 24 of the gullet plate 30 via a fastening device 28 having a flat design.

FIG. 5 shows a side view of a saddle tree 10 according to the invention having supporting elements 24a attached on the gullet plate 30 according to FIG. 4C. In this embodiment, the saddle tree 10 has two fastening devices 28 and a damping means 38 on the shanks 24 above the shank ends 21. The supporting elements 24a are designed such that they can function as points 15. Hence, the supporting elements 24a can adopt the functions from the state of the art of the points. For example, the supporting element 24a can be attached to the shank by means of two supporting points, which restricts the flexibility of the spatial movement of the supporting element 24a if desired.

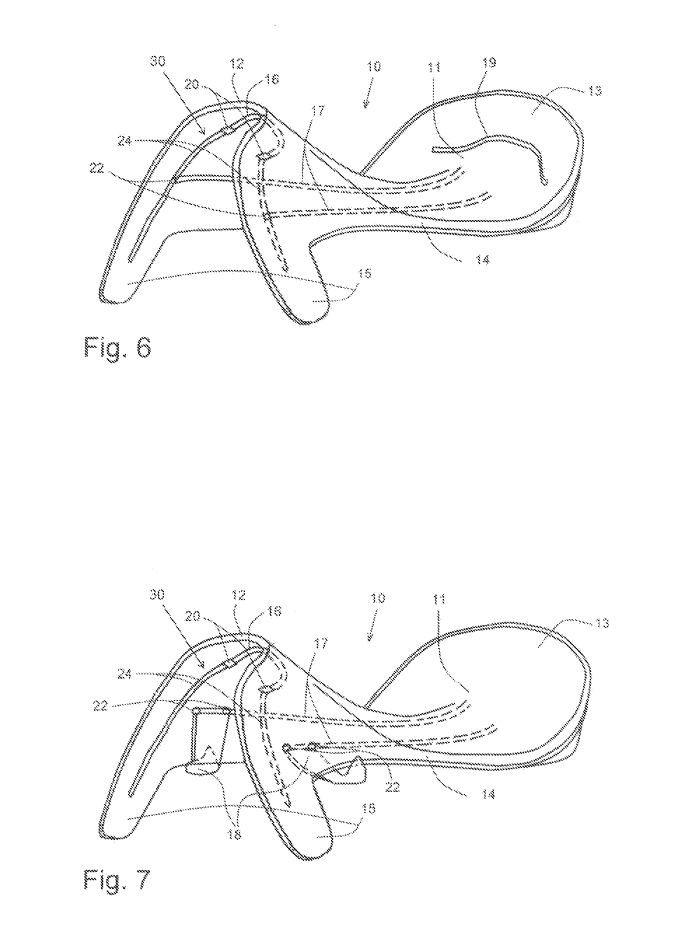

FIG. 6 shows a schematic view of another embodiment of the saddle tree 10 according to the invention, which is additionally reinforced by means of a cantle bar 19 and longitudinal bars 17, which are connected to the shanks 24 via the respective second mounting fixtures 22.

FIG. 7 shows a schematic view of another embodiment of the saddle tree 10 according to the invention, whose longitudinal bars 17 are connected to a stirrup bar 18 via the respective second mounting fixtures 22. In this embodiment of the invention, the shank 24 and stirrup bar 18 are individually reversibly detachable fixed, wherein in yet another embodiment of the invention each of the said stirrup bars 18 is provided with a second mounting fixture 22, which is attached to the gullet plate 30, on the saddle tree 10 and/or the stirrup bar 18 and is suitable to fix the stirrup bar 18 such that it can be reversibly detached. Depending on the embodiment of the invention, the fixing of the stirrup bar 18 can hence be dependent or independent from the fixing of the shank 24.

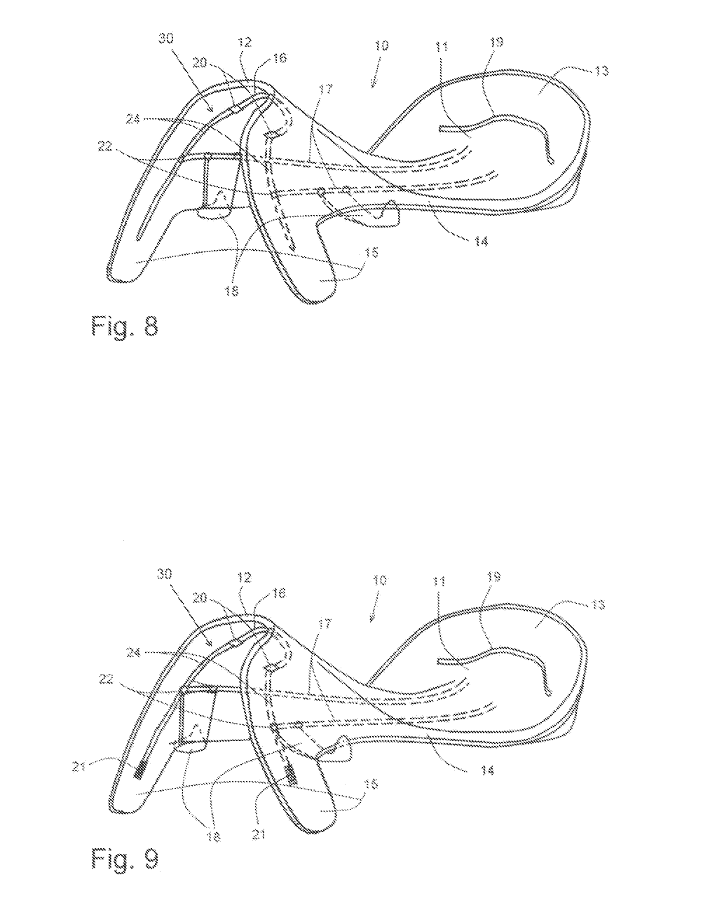

FIG. 8 shows a schematic view of another embodiment of the saddle tree 10 according to the invention, whose longitudinal bars 17 are connected to a stirrup bar 18 via the respective second mounting fixtures 22 and to the shanks 24 via the respective second mounting fixtures 22.

FIG. 9 shows a schematic view of another embodiment of the saddle tree 10 according to the invention, whose longitudinal bars 17 are firmly connected to a stirrup bar 18 and the shank 24 via the respective second mounting fixtures 22. The shanks 24 additionally have broadened shank ends 21.

In another embodiment of the invention, the saddle tree 10 has longitudinal bars 17, such that the shank 24 starts from the collar of the longitudinal bar 17 of the saddle tree 10, and from there onwards essentially encompasses the entire downward facing section. In yet another embodiment of the invention, the shank 24 is attached to the side of the horse, preferably starting from the padding line. According to the invention, the shank 24 is designed as one-piece but it can also be designed as multi-piece and optionally, connected to the points 15.

In yet another embodiment of the invention, the shank 24 is fixed to the gullet plate element 16 or the saddle tree 10 by means of at least one damping means 38 with flexible support. In another embodiment of the invention, the shank 24 and stirrup bar 18 are designed as one-piece. In an alternative embodiment of the invention, the shank 24 and stirrup bar 18 are designed as separate elements, i.e., the shank 24 and the stirrup bar 18 are not directly connected to each other or not designed as one-piece, whereby the shank 24 and the stirrup bar 18 are together or independently reversibly detachable fixed.

In another embodiment of the invention, the shank 24 is designed to be reversibly detachable fixed with respect to the mounting fixture 20, 22 such that the positioning of the shank 24 can be changed with respect to the saddle tree 10, the stirrup bar 18 and/or the gullet plate element 16 without completely dismantling the shank 24, i.e., the shank 24 can be moved or adjusted in the mounting fixture 20, 22 without being removed.

In an alternative embodiment of the invention, the shank 24 is designed to be reversibly detachable fixed with respect to the mounting fixture 20, 22 such that the shank 24 can be completely removed from the saddle tree 10 or gullet plate element 16, i.e., can be replaced (e.g., some other shank 24 in terms of weight, shape and/or material) by another one.

In another embodiment of the invention, the said first mounting fixture 20 is suitable for fixing the elements to be attached according to the invention by means of one or more suitable fastening devices. In a preferred embodiment of the invention, the first mounting fixture comprises a damping means 38.

The seating area 11 extends between the pommel 12 and the cantle 13 and may have a side cut 14. The longitudinal bars 17 are made of spring steel or elastically deformable material and extend between the cantle bar 19 and shanks 24. They can be connected to the gullet plate 30 by means of a second mounting fixture 22. For this purpose, the shank can be provided with a plurality of collars, such that the second mounting fixture is suitable in terms of a slide bar. In addition to the usual criteria for adjusting saddles, all the important anatomical parameters in the seating area 11 and in the area of the trapezoids of the horse can be changed in terms of position and orientation, i.e., angular position of the shank 24, shank end 21, stirrup bars 18 and longitudinal bars 17. The longitudinal bars 17 can also be designed in the shape of an S, whereby they are designed to taper together in the area of the side cut 14.

### REFERENCE NUMBER LIST

10 Saddle tree
11 Seating area
12 Pommel
13 Cantle
14 Side cut
15 Points
16 Gullet plate element
17 Longitudinal bar
18 Stirrup bar
19 Cantle bar
20 First mounting fixture
21 Shank end
22 Second mounting fixture
24 Shank/gullet plate shank
24a Supporting element
26 Longitudinal direction
27 Transverse direction
28 Fastening device (for supporting element 24a)
30 Gullet plate
32 Overlap
34 Crank
36 S-shaped arc
38 Damping means

We claim:

1. A modular saddle tree 10 for a riding saddle having a one-piece or multi-piece gullet plate 30, wherein the gullet plate 30 comprises
a) a gullet plate element 16 and
b) a shank 24, characterised in that
c) a supporting element 24a is attached to said shank 24 of the gullet plate 30 by means of a fastening device 28.

2. The saddle tree according to claim 1, wherein the supporting element 24a is flexibly attached by means of the said fastening device 28.

3. The saddle tree according to claim 1, wherein the supporting element 24a is flexibly attached by means of the said fastening device 28 such that it is moveably mounted.

4. The saddle tree according to claim 1, wherein said supporting element 24a is reversibly detachable attached.

5. The saddle tree according to claim 1, wherein the shank 24 is reversibly detachable fixed to the gullet plate element 16 by means of a first mounting fixture 20.

6. The saddle tree according to claim 1, wherein the gullet plate 30 is cranked.

7. The saddle tree according to claim 1, further comprising a stirrup bar 18, wherein the stirrup bar 18 is fixed to the saddle tree independently from the shank.

8. The saddle tree according to claim 1, further comprising a stirrup bar 18, wherein the stirrup bar 18 is reversibly detachable fixed to the saddle tree 10 independently from the shank by means of a second mounting fixture 22.

9. The saddle tree according to claim 1, further comprising a stirrup bar 18 wherein the shank 24 and stirrup bar 18 are designed as one-piece.

10. The saddle tree according to claim 1, further comprising a stirrup bar 18, wherein
a) the stirrup bar 18 is fixed to the saddle tree independently from the shank and
b) the said first mounting fixture 20 is designed to variably adjust at least one angle between the stirrup bar 18 and the shank 24.

11. The saddle tree according to claim 1, further comprising a stirrup bar 18, wherein the shanks 24 and/or the stirrup bars 18 are fixed using a damping means.

12. A riding saddle comprising a saddle tree as defined in claim 1.

13. A shank comprising
a) a fastening device 28 for a supporting element 24a and
b) a supporting element 24a as defined in one or more of claims 1 to 4.

14. A shank according to claim 13 for fixing to a first mounting fixture 20 of a gullet plate element 16 as defined in claim 5, characterised in that the said shank is reversibly detachable fixed in a positive-fit or force-fit manner by means of the said mounting fixture 20.
